(19) United States
(12) Patent Application Publication
(10) Pub. No.: US 2024/0361442 A1
(43) Pub. Date: Oct. 31, 2024

(54) IMPROVING RF SENSING WITH DISCRETE CHRIP TRANSMISSIONS

(71) Applicant: SIGNIFY HOLDING B.V., EINDHOVEN (NL)

(72) Inventors: HUGO JOSÉ KRAJNC, EINDHOVEN (NL); PETER DEIXLER, ARLINGTON, MA (US)

(21) Appl. No.: 18/556,412

(22) PCT Filed: Apr. 11, 2022
(86) PCT No.: PCT/EP2022/059576

§ 371 Date: Oct. 20, 2023

Related U.S. Application Data
(60) Provisional application No. 63/178,179, filed on Apr. 22, 2021.

(30) Foreign Application Priority Data
May 18, 2021 (EP) 21174229.1

(51) Int. Cl. G01S 13/00; G01S 7/35; G01S 13/88

(52) U.S. Cl. CPC G01S 13/003; G01S 7/354; G01S 13/88

(57) ABSTRACT

A radio frequency (RF) sensing system (100) is provided comprising a RF transmitter (110) for wirelessly transmitting RF sensing signals (400) which comprises a group of n independent and subsequent messages (412-416) each modulated with a different frequency (412a-416a). The frequencies (412a-416a) of the subsequent messages (412-416) change in steps. Furthermore, an RF receiver (120) for receiving the group of n 5 subsequently transmitted messages (412-416) and a controller (130) are provided for performing a sensing operation based on the received group of n transmitted messages (412-416) each transmitted with their respective frequency (412a-416a).

### FIELD OF THE INVENTION

The present invention relates to a radio frequency sensing system, a method of radio frequency sensing and a radio frequency sensing signal.

### BACKGROUND OF THE INVENTION

Radio frequency (RF) based sensing of obstacles or movement allow a contactless sensing between wireless devices which send and receive RF signals. A wireless RF signal interacts in space with static and dynamic objects. A level of interaction with a static or dynamic object (like reflection, absorption, scattering) depends among others on the frequency of the RF transmission. A signal with a higher frequency may have a higher absorption on the objects than a signal sent at a lower frequency. Several wireless metrics can be used for motion detection. Such metrics can be a channel state information (CSI), received signal strength indication (RSSI), etc. The metrics like the received signal strength indication RSSI or the channel state information CSI can be sufficient for simple motion detection but the accuracy thereof may not sufficient for high-context awareness applications (like breathing detection). To improve the accuracy of the RF sensing, the number of paths of the wireless signal can be increased as it enhances a chance of interaction between the RF signals and the objects.

The article “Multi-Target Device-Free Wireless Sensing Based on Multiplexing Mechanisms” by J. Wang et al., IEEE TRANSACTIONS ON VEHICULAR TECHNOLOGY, volume 69, pages 10242 to 10251 (2020) describes an active radar sensing at 77 GHz.

U.S. Pat. No. 5,959,573A discloses a bistatic coherent unlocked radar system and processing method using an advanced waveform that permits bistatic unlocked coherent operation of an unlocked radar transmitter and receiver. The waveform implements intrapulse fine range resolution, pulse to pulse coherency and burst to burst frequency agility to provide for enhanced target detection and robust operation in electronic countermeasure environments.

### SUMMARY OF THE INVENTION

It is an object of the invention to provide a radio frequency sensing system with an improved sensing accuracy but without significantly increasing the hardware complexity of the system.

A radio frequency sensing system is provided which comprises at least one RF transmitter configured to transmit RF sensing signals. At least one of the RF sensing signals comprises a group of n independent and subsequent messages each modulated with a different frequency. The group of n messages may be sent within a (predefined) time interval. Such a time interval may also allow for jitter and variations in the timing of the transmission of the messages. The frequencies of subsequent messages change (not continuously but in steps). Furthermore, at least one RF receiver is provided to receive the number of subsequently transmitted messages of the at least one RF sensing signal. The radio frequency sensing system furthermore comprises a controller which performs a sensing operation (and an analysis) based on the received number of transmitted messages which have been transmitted each with a different frequency. The frequencies associated to each of the number of messages are within a predefined frequency range having an upper frequency and a lower frequency. Optionally, the at least one RF transmitter and the at least one RF receiver are arranged spaced apart from each other. Hence, they can be arranged at different locations.

Hence, a number of messages is transmitted from the transmitter to the receiver. The messages will interact with objects in a sensing area while they are wirelessly transmitted. As the frequency changes, at which each of the subsequent message is each transmitted a frequency sweep is enabled. Hence, every message from the n messages is transmitted at a different frequency. Therefore, the interaction of the RF signals with subjects (humans, pets, animals, physical objects, building materials) in the sensing area can be determined for various frequencies thus significantly improving the accuracy and the robustness of the RF sensing without increasing the hardware costs. As each message is transmitted at its own dedicated frequency, the interaction of this message with objects in the sensing area can be determined at the decoding process.

Hence, transmitting a group of n messages each at a different frequency can greatly improve the robustness and accuracy of the RF sensing system.

According to an example, the frequencies of the subsequent messages have ascending or descending values (or steps) within the frequency range. Therefore, the interaction between the wireless signals and the objects can be detected for a range of neighboring signals or neighboring frequencies or frequency bins.

According to an example, the frequencies within the frequency range between the upper and lower frequency can be divided into frequency bins according to the number of messages of the RF sensing signal. Accordingly, by increasing the number of messages, the granularity of the RF sensing can be improved as also the number of frequency steps or frequency bins is increased.

According to a further example, the frequencies of the subsequent messages have a predefined sequence within the frequency range. Hence, the frequencies of subsequent messages do not have to be ascending or descending. Optionally, the sequence of the n messages can be determined or set beforehand. This is advantageous as the granularity of the RF sensing can be improved at specific frequency ranges where for example an interaction between the RF signals and the objects are believed to be of higher importance. Alternatively, those frequency ranges which are believed to have no or less sensitivity of the interaction can be skipped.

According to this example, the group of n messages can be transmitted in a preselected or hard-coded sequence e.g. first the even channels and then the odd channels. Alternatively, the best type of sequence can be dynamically determined depending on an earlier estimation of activity, a confidence level, context metadata, etc. Here, for example a pre-selected sequence (e.g. first the even channels and then the odd channels approach) of frequency changes for the number of messages can be performed. However, if the context changes, the sequence of the frequencies of the n messages can be dynamically chosen. E.g. first the center frequency channels and then the outer frequency channels are used to transmit the number of messages. Hence, the sequence of the frequencies at which the number of messages are transmitted can be dynamically selected to be able to react to a changing environment, changing network parameter or activities in the sensing area.

According to a further example, the n messages and thus the granularity of the frequency bins can be adapted based on expected events or movements of the subject. Furthermore, the n messages can be adapted based on the sensing operation performed by the controller. Hence, if the controller determines that the sensing operation is not sufficient at certain frequency bins, the number n of messages can be adapted. Optionally, the frequency steps between subsequent messages can have a non-linear relationship. Thus, the frequency steps can be smaller at subranges in the frequency range such that more information can be gathered at these frequencies.

According to an example, the controller can adapt the number of messages in one group or can adapt a duration of the group of n messages or a duration of the respective messages according to results of the sensing operation.

According to a further example, the controller can set the frequencies of the subsequent messages in non-linear frequency steps.

According to an example, the controller can select the number n of messages and their respective frequencies based on environmental information or building material information.

According to an example, the group of n messages also comprise a preamble message having information regarding the number n, and frequency information regarding the frequencies of the n messages.

According to an example, the controller can adapt a transmission power of at least one of the n messages to be transmitted at the associated frequency. This can be advantageous if the to-be-detected person is located at a first spot in the room involving a multi-path with reflections, resulting in a long path length for this multipath. The higher RF frequencies will suffer from more absorption in the air than the lower RF frequencies. Hence, depending on the path length associated with the location of the to-be-detected first person, the transmit power of the higher frequency may be increased compared to the transmit power of the lower frequency, if currently a long multipath is involved in the sensing of the person.

According to an example, at least one of the n messages comprise information regarding a number of upcoming messages, and/or frequency information regarding frequencies of the upcoming messages. Hence, a distributed preamble can be provided enabling a more robust transmission of the information of the preamble. Some of the n messages may for example comprise information regarding the frequency of the subsequent message.

According to an example, a method of radio frequency sensing is provided. RF sensing signals are wirelessly transmitted by a RF transmitter. At least one of the RF sensing signals comprises a group of n independent and subsequent messages each modulated with a different frequency wherein the frequencies of the subsequent messages change in steps. The group of n subsequently transmitted messages are received by a RF receiver. A sensing operation is performed based on the received group of n messages each transmitted with their respective frequency. The frequencies associated to the group of n messages are within a frequency range having an upper frequency and a lower frequency.

According to an example a radio frequency RF sensing signal is provided. The RF sensing signal comprises a group of n independent and subsequent messages each modulated with different frequencies. The frequencies of the subsequent messages change in steps. The frequencies associated to the group of n messages are within a frequency range having an upper frequency and a lower frequency.

According to an example, the RF sensing signal comprises a preamble message comprising information regarding the number n, and frequency information regarding the frequencies of the n messages.

According to an example, the radio frequency sensing system can have a primary function for example like lighting, a secondary function like wireless communication between lighting elements and additionally the RF sensing function. The RF transmitter and the RF receiver can thus be part of a lighting unit. The RF transmitter and the RF receiver can be embodied as a RF transceiver. The RF transmitter and the RF receiver can be implemented in a lighting unit such as a luminaire.

According to a further example, the RF sensing signals may comprise an announcement, a prefix or preamble message. This message may comprise information about the RF sensing signal to be transmitted. This information may include the number of messages and their transmission frequencies. Moreover, the duration of the transmission may also be included.

According to a further example, the transmitter will refrain from sending any other messages between the group of n independent and subsequent messages.

The RF sensing may include motion sensing, activity sensing, people counting and position detection. The RF sensing may further include the detection of motion like person moving, a person performing activities, fall detection, breathing detection, gesture detection. The RF sensing may also be used for detecting a composition of materials (chemical, biological). Moreover, the RF sensing may be used for motion or movement detection (like the movement of ventilator blades or the movement of robots in a warehouse). The RF sensing can be performed in or for a sensing area which can be in the room or area where the RF transmitter and the RF receiver is arranged. The RF sensing may also be performed for a sensing area which is different from the position of the RF transmitter or the RF receiver. Hence, remote sensing can be enabled.

According to an example, optionally a message may correspond to a minimum amount of information that can be transmitted. According to an example, the messages used in the RF sensing signal can be standard WiFi messages. Advantageously, the different standard WiFi messages are used on different WiFi channels.

It shall be understood that the RF sensing signal of claim 1, the RF sensing method of claim 10, the RF sensing signal of claim 11 and the computer program product of claim 13 have similar and/or identical preferred examples, in particular as defined in the dependent claims.

According to an example, a computer program product for controlling a radio frequency sensing system is provided. The computer program product comprises program code means causing the radio frequency sensing system to execute a method as described above.

It shall be understood that a preferred embodiment of the present invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows a schematic representation of an RF sensing system,

FIG. 2 shows a schematic representation of a flow chart of an RF sensing method,

FIG. 3 shows a graph depicting the changes of signal amplitude and the changes of the signal frequency over time for radio frequency sensing signal,

FIG. 4 shows a schematic representation of a lighting system, and

FIG. 5 shows exemplarily the attenuation of radiofrequency signals for different materials.

### DETAILED DESCRIPTION OF EMBODIMENTS

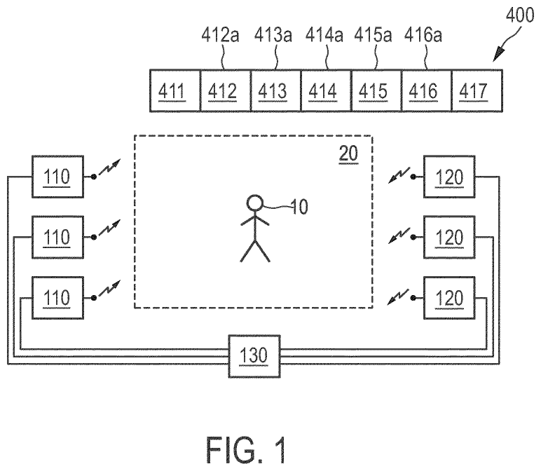

FIG. 1 shows a schematic representation of a radio frequency RF sensing system. The RF sensing system 100 comprises at least one RF transmitter 110, at least one RF receiver 120 and a controller 130. The RF transmitter 110 wirelessly transmits an RF sensing signal 400, which interacts with at least one object, subject or person 10 in a sensing area 20 before the transmitted RF signal 400 is received by one of the RF receivers 120. The controller 130 performs an RF sensing based on the received RF sensing signals received by the receiver 120. Optionally, the at least one RF transmitter 110 and the at least one RF receiver 120 are provided as physically separate devices, which are arranged spaced apart from each other. Hence, they can be arranged to different locations e.g. in the sensing area 20). The transmitter 110 and the receiver 120 can also each be implemented as transceivers. The receiving transceiver can be arranged spaced apart from the transmitting transceiver.

One of the RF sensing signal 400 can comprise a group of n messages 412-416 which are transmitted independently and subsequently each with a different frequency 412a-416a. Optionally, the group may also comprises a preamble or announcement message 411 and an end message 417. The controller 130 analyses the received n message 412-416 to perform a sensing operation. Optionally, the controller 130 performs a separate sensing operation for each received message 412-416. As each message 412-416 is transmitted with a different frequency 412a-416a, the controller 130 will perform n sensing operations each for a different frequency. Thus, the controller 130 can extract information on the interaction between the RF sensing signals, subjects and objects 10 in the sensing area at different frequencies 412a-416a.

The RF sensing signal 400 in form of the group of n messages can be transmitted as a burst. Hence, all n messages 412-416 can be transmitted subsequently one after the other. Furthermore, the n messages 412-416 can be transmitted substantially without any interruption or delay, for example by any other messages or signals. As each of the n messages 412-416 are transmitted at a different frequency 412a-416a, the number n determines the granularity of the frequency bins. The sweeping range of the frequencies is determined by the upper and lower frequency of the frequency range.

The preamble or announcement message 411 can be used to transmit information regarding the number n of messages, the frequencies to be used etc. Thus, the receiver 120 will know the number of messages to be expected as well as the frequencies at which these messages are transmitted. The end message 417 can be used to signal the end of the RF sensing signal.

The frequency range for the RF sensing signals can be for example between 2.405 GHZ to 2.48 GHZ for a Zigbee spectrum. Alternatively, a band of 60 MHZ around a center frequency can be selected. The number of frequency bins depends on the number n of messages to be transmitted. Optionally, the frequency bins can be selected as n-equally distance frequencies in the frequency range or frequency e.g. for every 3 MHz along the full frequency range. The sweeping order can be ascending frequency, descending frequency or a predefined unsorted order. Alternatively, the sweeping order can be dynamically determined e.g. based on previous measurements, environmental information and/or building material information. The sweeping order can also be transmitted with the preamble message 411.

Preferably, the n messages (together with the preamble and the end message) are transmitted as a group of n messages in a burst subsequently and independently of each other.

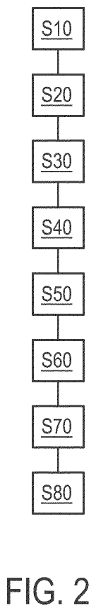

FIG. 2 shows a schematic representation of a flow chart of an RF sensing method. In step S10, a frequency range for the group of n messages is determined. In step S20, a number n of messages 412-416 is determined. In step S30, the frequency steps or frequency bins 412a-416a are determined based on the frequency range and the number n of messages. Optionally, the sweeping order (ascending, descending, predefined order or dynamical order) is determined. Optionally, in step S40, a preamble or announcement message 411 is transmitted. This preamble or announcement message may comprise information on the number of messages, the frequency steps or frequency bins. In step S50, the RF sensing signal is transmitted by transmitting the number n messages 412-416. In step S60, the transmitted n messages 412-416 are received by a receiver 120. The received n messages (each at a different frequency) have interacted with objects or subjects 10 (humans, pets, animals, physical objects, and/or building materials) in a sensing area 20. In step S70, sensing information is extracted from the received n messages 412-416.

Optionally, in step S80, the number of messages and/or the frequency range if adapted depending on the sensing scenario. Optionally, the number n of messages and the frequency bins can be adapted according to the information extracted in step S70.

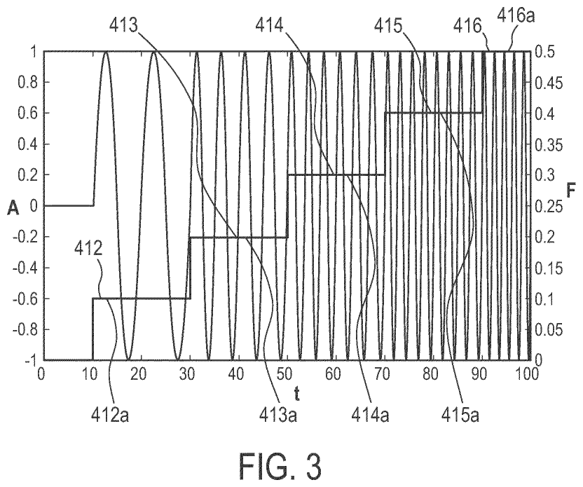

FIG. 3 shows a graph depicting the changes of signal amplitude and the changes of the signal frequency over time for radio frequency sensing signal. In FIG. 3, the signal amplitude as well as the signal frequency are depicted over time. While the signal amplitude may stay constant, the frequency of the signal is changed over time in steps. In FIG. 3, the frequency is increased in steps. A first message 412 is transmitted at a frequency 412a. Then the next message 413 is transmitted at a further frequency 413a, which is higher than the previous frequency. The following messages 414, 415 and 416 are each transmitted at a frequency 414a, 415a, 416a, wherein the frequencies increase in steps. Accordingly, instead of a linear frequency increase over time, the RF sensing signal is divided into messages which are independently transmitted at a different frequency.

With the RF sensing signal having a group of n messages transmitted at n different frequencies, a sweep of different frequency channels can be used for RF sensing. The n messages can be transmitted as bursts.

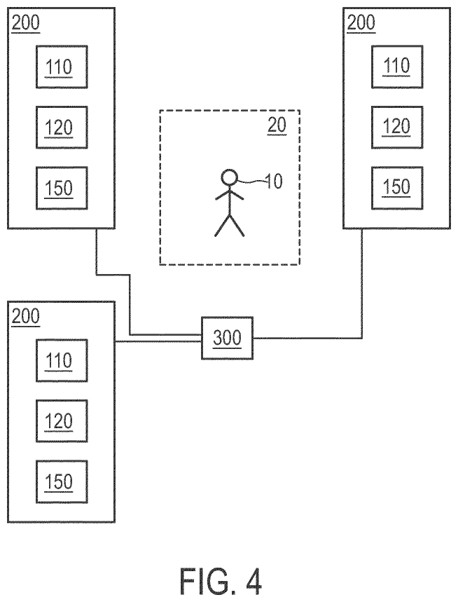

FIG. 4 shows a schematic representation of a lighting system. The lighting system comprises a number of nodes 200 and a controller 300. The nodes 200 can be arranged in or around an area 20 where objects or people 10 may be present. The nodes 200 can comprise a transmitter 110, a receiver 120 and a lighting unit 150. The transmitter 110 and the receiver 120 can also be implemented as a transceiver. The lighting unit 150 is used to provide light for the area 20. The transmitter 110 and the receiver 120 may wireless communicate with each other and/or with the controller 300 to activate or deactivate the lighting units 150. The receivers 120 and transmitters 110 may correspond to the receivers 120 and transmitters 110 of FIG. 1.

According to an example, the hardware of the transmitters 110 and receivers 120 can be used for communication purposes between the nodes 200. Additionally, the hardware of the transmitters 110 and receivers 120 may also be used for a secondary purpose, namely RF sensing as described with reference to FIG. 1.

According to an example, the transmitter 110 and the receiver 120 can be part of a system with a different function such as lighting. Thus, the transmitter and the receiver are also used for communication purposes between different RF nodes in an RF system. Accordingly, the RF sensing system may be implemented as a system piggy bagged onto a primary system. Accordingly, the hardware (like the transmitter and the receiver of the primary system) are also used by the RF sensing such that the RF sensing can be a secondary function using the same hardware components as the primary system.

The primary system can be a lighting system having a number of lighting units, wherein each lighting unit is coupled to a transmitter and receiver. The transmitter and receiver can also be implemented as transceivers. In other words, the transmitters and receivers can be primarily used for communication between RF nodes like lighting units. Their secondary function can be the RF sensing.

The controller can also be used to control the communication between RF nodes to enable the primary function of the system (for example lighting).

According to an example, the RF sensing system of FIG. 1 can also perform an RF sensing on multiple objects or persons in the sensing area.

According to an example, at least two RF transmitters 110 and two RF receives 120 are provided as two pairs in a sensing area. The RF transmitters can each transmit RF sensing signals. To improve the accuracy of the RF sensing, range division multiplexing may be used to determine different objects in the sensing area. The transmitters can be arranged spaced apart from each other.

According to an example, the messages used in the RF sensing signal are standard WiFi messages. Advantageously, the different standard WiFi messages are used on different WiFi channels.

Each frequency associated to one of the n messages 412-416 may correspond to a wireless communication channel in the wireless communication architecture used by the RF sensing system.

According to an example, the controller 130 can determine those frequencies which are received by the receivers 120 or by any other receiver in the system. Based on the received frequencies, the controller can initiate a frequency range at the transmitters in order to avoid certain frequency ranges, which may be used by external devices. Moreover, the controller may control the transmitters to use a lower granularity at specific frequency ranges, where interference is expected. Thus, the amount of interference on the transmitted n messages can be reduced, while still enabling an improved accuracy of the RF sensing. The controller 130 can thus set or adapt the frequency range for the RF sensing signal, the frequency sweeping order and/or a delay between subsequent messages 412-416. The messages which may contain less important information can be transmitted at those frequencies where interference is expected or detected.

The controller 130 can thus initiate a transmission of those messages that have frequency modulations which are less important for the RF sensing than others. On the other hand, the controller can start with those messages which frequencies are most important for the RF sensing. Accordingly, the controller can determine the order of transmission of the n messages based on their frequency channels or frequencies.

According to a further example, the RF sensing signal is transmitted as a burst sequence without interruption of at least the n messages 412-416.

According to a further example, the controller 130 is adapted to ensure an interference free transmission period for the RF sensing signal. It should be noted that this function can also be implemented by any other element in the RF sensing system. The interference-free transmission period can be achieved by controlling the transmitter 110 or the transmitters 110 in the RF sensing system to refrain from transmitting any other messages than the n messages 412-416 (including the preamble message 411 and the end message 417). The controller may also control the other transmitters in the system to refrain from transmitting any messages when one of the transmitters is transmitting the RF sensing signal.

Furthermore, the preamble or announcement message 411 can be used to notify other transmitters in the system to refrain from transmitting messages for the time period when the RF sensing signal is to be transmitted. In particular, the transmitters should refrain from transmitting at least for the time period required for the RF sensing signal.

The preamble or announcement message 411 may comprise a command (known by the other transmitters) to signal the other transmitters to refrain from transmitting messages. Such commands can relate to higher layers of application. Each receiver which receives such command can forward this command within its RF node to signal the corresponding transmitter to refrain from transmitting.

Additionally or alternatively, the announcement or preamble message 411 may use a higher transmitting power or a longer payload. In particular, such a preamble or announcement message may use characteristics of the physical layer to directly or indirectly signal to the other transmitters to refrain from transmitting.

According to an example, the above described RF sensing technique can be used to simultaneously track two or more object or subject in a sensing area.

According to a further example, e.g. two or more different RF sensing pairs (a RF transmitter and a RF receiver) in the sensing area can be used to transmit identical groups of n messages. Here, the RF sensing system (e.g. in form of a WiFi system) can employ range division multiplexing to separate out different human targets, object or subjects. Preferably, the first RF sensing pair is at a first distance to the first person, subject or object, while the second RF sensing pair is at a second distance to the second person, subject or object, and the first and second distance are substantially different. If several RF transmitters and RF receivers are present in the sensing area and if multiple human targets, object or subject are to be tracked, those RF transmitters and RF receivers are selected which have different ranges towards the respective sensing target area. Hence, the position of the RF transmitters and RF receivers can be an important parameter during the selection of the RF transmitters and RF sensors.

In the following an implementation of the above described radio frequency sensing system in building is described in more detail. State-of-the-art RF sensing is known to have unreliable sensing performance a) if the radio frequency signal has to transmit over a long distance, e.g. in a garden setting, or b) if an inter-floor sensing is utilized, e.g. in office applications, when RF transmitter e.g. in form of network devices on a first floor are used to sense for people walking on an above lying second floor. Furthermore, if highly absorbing building materials are present in the sensing area an effective rendering a subset of the signal multi-paths can be useless for Channel State Information CSI-based sensing. In the above cases, the attempt to analyse each of the multi-path signal components of a CSI signal separately, as done by CSI-based sensing, may lead to inconclusive results due to insufficient signal-to-noise ratio of most available signal multi-paths. Even if the sensing algorithms may provide useful data, it may be more prone to false positives or false negatives, or incorrect estimation of metrics like breathing rate or heart rate and thus will comprise a decrease accuracy and reliability. Current state-of-the-art breathing detection/sleep monitoring solutions are, for instance, not capable to concurrently perform RF sensing for two people sharing the same bed. The above described RF sensing system allows to improve the sensing performance for such challenging settings.

As the different subsequent n messages (412-416) are each modulated with a different frequency, such frequencies will interact differently with the buildings materials in the sensing area. Hence, while the building material may strongly reflect the signal at a first frequency it may reflect less at a second frequency. Hence, each of the different sensing frequencies employed in our invention will have a different wireless multipath characteristics of the sensing signal in the room.

Hence, the above described technique of transmitting a group of n messages each at a different frequency can greatly improve the robustness and accuracy of the RF sensing system.

According to an example, the RF transmitter and the RF receiver can optionally be implemented as a RF transceiver. Alternatively, the RF transmitter and the RF receiver may be implemented in the same network device.

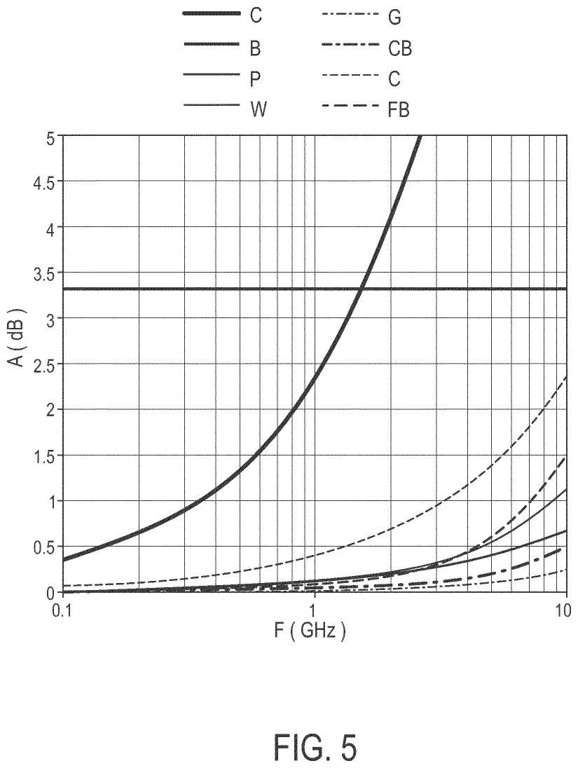

FIG. 5 shows measurements of an attenuation for various building materials within a typical frequency range used by radio frequency sensing applications. From FIG. 5 it can be concluded that the differences in attenuation among different materials are very pronounced. In FIG. 5 an attenuation A (dB) is depicted on the Y-axis and the frequency F in (GHz) is depicted on the X-axis. In particular the relationship between the frequency F and the attenuation A is depicted for concrete C (100 m thickness), for brick B (103 mm thickness), for plasterboard P (12 mm thickness) for wood W (18 mm thickness), for glass G (6 mm thickness), for ceiling board CB (50 mm thickness), for clipboard C (18 mm thickness) and for floor board FB (18 mm thickness).

To illustrate the strong influence of the chosen RF sensing frequency on the signal strength for the different multi-paths in the room, in the following a review of how radio waves interact with different commonly used building-materials is provided. Radio waves are propagated through electromagnetic radiation and interact with the environment by reflection, refraction, diffraction, absorption, polarization, and scattering. Hence, the construction form of room as well as the spatial arrangement and integral-surface-area of each present building material type can influence a radiofrequency multi-path signal characteristic of this particular room. For a typical wireless link budget of 90 dB, defined by max. transmission Tx power to min. Rx sensitivity, total, a difference in wireless attenuation of just a couple dB caused by a building material is well within the detectable range of a radiofrequency sensing system. Metallic materials present in an area strongly affect the radiofrequency signal multi-path propagation. Over the last decades, metallic construction materials are increasingly often being used, for instance, to improve a thermal isolation performance of houses. For example, in most modern houses nowadays aluminum foils are incorporated into foil-backed plasterboard and insulation boards to provide low thermal emissivity as well as vapor resistance, while having minimal impact on the room dimensions. For instance, “multi-foil” building products are often stapled to roof eaves, cavity-walls or are laid on loft floors. As these multi-foil building materials may typically consist of more than ten layers of aluminum foil and insulation, a dormer window space or an attic of a house may exhibit very different radiofrequency sensing signal propagation pattern compared to the same home's living room, which does not feature aluminum building material. Similarly, mirrors e.g. in a bathroom or dressing room are known to cause strong reflections. Similarly, most modern houses feature low emissivity window-glazing to improve the thermal performance by adding a thin metallic or metallic oxide layer to one of the glass panes. The thin metallic layer on the window glass affects the wireless signal propagation of the subset of RF multipath transmissions involving the window area. As changes in construction methods and materials have deteriorated the building penetration losses of cellular signals, modern buildings now also deliberately create a small portion of certain walls on purpose such that cellular signals can penetrate freely to-the-inside of the home as well from a first room to a second room. However, these “odd” spots in the building walls inadvertently also influence a radiofrequency sensing signals multi-path propagation, for instance allowing radiofrequency sensing signals to inadvertently leak out of a room, e.g. from a kitchen through the wall to an adjacent living room.

Hence, it is advantageous for a radio frequency sensing system to utilize many different RF sensing frequencies, e.g. like the above transmission of a group of n messages eliciting different interactions of the sensing signals with the building materials used in a room. The RF sensing system may also understand how specific portions of the room reflect, absorb, or scatter the radiofrequency signals (see Alexandra's patent applications) and thereupon adjust the choice of frequencies in the stepped sensing approach.

The two most easily understandable interaction mechanisms between radio waves and building materials are reflection and absorption. For all practical purposes, large metallic structures, such as steel beams and radiators in a room, can be regarded at the radio frequency sensing frequencies of interest as perfect reflectors. Hence, unlike thin metal films described earlier, these thick metal structures do not allow significant radiofrequency sensing signal to pass through. Any reflections of the radiofrequency sensing signal, for instance, by the aforementioned large metallic structures, will create additional multi-path components to the radiofrequency signal transmission channel between the two radiofrequency sensing network devices. In practice, the strongest reflection effects will be produced by large, smooth, planar building objects, such as walls, floors, ceilings, windows, doors, as the surfaces of these objects typically are fairly smooth at the typical radiofrequency sensing frequencies used and thus these objects very strongly reflect the wireless radiofrequency sensing signals.

Diffraction is yet another mechanism that can influence radiofrequency sensing multi-path signals in a room. Diffraction of radio waves occurs where two different building materials meet, or where there is a sharp change in the shape of the surface of a material. In practice, diffraction of radiofrequency signals occurs in buildings typically at corners and edges where two or more walls/ceilings meet, and at the edges of windows and doors where wood or glass panels meet walls. While diffraction is generally a “weaker” mechanism than transmission for getting radiofrequency signals from one sub-space in the building to another, prior art also teaches that diffraction occasionally can be even the dominant mechanism for providing cellular or home-WiFi radio coverage at certain location inside a room or building. For instance, diffraction may significantly contribute to deliver wireless radiofrequency signals to a blind spot area behind a highly attenuating metal wall or large metal object. In this specific “blind spot” location, the radiofrequency signal diffracted from elsewhere in the room may even be much stronger than the radiofrequency signal reaching the receiver directly through the obstructing object or via reflections. Prior art teaches that the strength of a diffracted wireless radiofrequency signal depends principally on the path geometry, shape of the diffracting edge and the frequency. It also depends to some extent on the electrical properties of the material comprising the diffracting edge, e.g. corner of gypsum wall sticking into room reinforced with a long metal stripe, but this dependence is generally weaker than the other factors.

Another interaction mechanism between sensing radio waves and building materials is wireless scatter. Prior art teaches that the large-sized clutter such as furniture and people present in the room can often be modelled as scatter sources even at relatively low frequencies such as 2.4 GHZ. In addition, wireless scatter can also occur when a radio wave impinges on a rough surface. Whether a surface appears rough or smooth at radiofrequencies depends on the relative sizes of surface irregularities compared to the wavelength, and on the angle of incidence of the radio wave. At 2.4 GHZ, the wavelength is approximately 12.5 cm, hence, if the irregularities are less than a tenth of a wavelength, 1.25 cm in the case of 2.4 GHZ, the surface can be considered smooth at all angles of incidence. At the wavelengths currently used by network devices for radiofrequency sensing most internal and external walls can therefore be considered as smooth and the effects of scatter will be negligible. However, if the RF sensing frequency can be increased for instance to 60 GHz WiFi (λ=0.5 cm), surface irregularities of 0.5 mm will already cause noticeable scatter in the radiofrequency signal propagation. Hence, 60 GHz will cause scatter effects beneficial for detecting with RF sensing clutter, e.g. kitchen tools, on a smooth tabletop.

According to an example, the above RF sensing technique may be used with CSI-based sensing or RSSI-based sensing. In general, CSI-based sensing modes are preferred, as these provide in principle more insights than RSSI based sensing modes. However, the inventors have found that under certain circumstances RSSI-based sensing modes are preferred due to the presence of certain building materials greatly influencing the room's multi-channel behavior. Similarly, for certain high-value sensing applications, e.g. breathing or heartrate detection, it may be required to purposefully modify a CSI-based sensing mode by selecting a sub-set of radiofrequency signal multi-paths in a room to be used by the CSI-sensing mode.

Thus, the inventors have noted that, in practice, selection criteria for which RF sensing frequencies to use for the proposed RF sensing method may depend on the physical properties of a room, like surfaces, materials, shape. Hence, the RF sensing system as described above is adapted to first utilize the environmental information, for instance, to analyze and localize the building materials present in a room, wherein the environmental information can be provided, for instance, via a panoramic scan, a LiDAR scan or a user-input during commissioning. Subsequently, the system can be adapted such that the collected building material information, or environmental information, serves as input to the controller 130 when selecting the number n of messages and their respective frequencies. Further, determining optimal radiofrequency sensing settings due the room's materials may be also useful for concurrently monitoring the breathing of two people sharing the same bed. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

Procedures like transmitting or receiving RF signals and analyzing the received RF signals, performed by one or several units or devices can be performed by any other number of units or devices. These procedures, particularly transmitting or receiving RF signals and analyzing the received RF signals, can be implemented as program code means of a computer program and/or as dedicated hardware.

A computer program may be stored/distributed on a suitable medium, such as an optical storage medium or a solid-state medium, supplied together with or as part of other hardware, but may also be distributed in other forms, such as via the Internet or other wired or wireless telecommunication systems.

Any reference signs in the claims should not be construed as limiting the scope.

1. Radio frequency (RF) sensing system, comprising
at least one RF transmitter configured to wirelessly transmit RF sensing signals,
wherein at least one of the RF sensing signals comprises a group of n independent and subsequent messages each modulated with a different frequency, wherein the frequencies of the subsequent messages change in steps,
at least one RF receiver configured to receive the at least one group of n subsequently transmitted messages, wherein the at least one RF transmitter and the at least one RF receiver which is receiving the RF sensing signal transmitted by the at least one RF transmitter are arranged spaced apart from each other and arranged to different locations in a sensing area, and
a controller configured to perform a sensing operation based on the received group of n transmitted messages each transmitted with their respective frequency, wherein the sensing operation is based on Channel State Information (CSI)-based sensing or Received Signal Strength Indications (RSSI)-based sensing,
wherein the frequencies associated to each of the group of n messages are within a frequency range having an upper frequency and a lower frequency, and wherein the controller is further configured to adapt the n messages based on the sensing operation performed by the controller.

2. Radio frequency sensing system according to claim 1, wherein
the frequencies of the subsequent messages in one group have ascending or descending values within the frequency range.

3. Radio frequency sensing system according to claim 1, wherein
the frequencies of the subsequent messages in one group have a predefined sequence within the frequency range.

4. Radio frequency sensing system according to claim 1, wherein
the controller is configured to adapt the number of messages in one group or to adapt a duration of the group of n messages or a duration of the respective messages according to results of the sensing operation.

5. Radio frequency sensing system according to claim 1, wherein
the controller is configured to adapt a transmission power of at least one of the n messages.

6. Radio frequency sensing system according to claim 1, wherein
the controller is configured to set the frequencies of the subsequent messages in non-linear frequency steps.

7. Radio frequency sensing system according to claim 1, wherein
the controller is configured to select the number n of messages and their respective frequencies based on activity in a sensing area, environmental information or building material information.

8. Radio frequency sensing system according to claim 1, wherein
the group of n messages also comprise a preamble message having information regarding the number n, and frequency information regarding the frequencies of the n messages.

9. Radio frequency sensing system according to claim 1, wherein
at least one of the n messages comprise information regarding a number of upcoming messages, and/or frequency information regarding frequencies of the upcoming messages.

10. Method of radio frequency sensing, comprising the steps of:
wirelessly transmitting RF sensing signals by at least one RF transmitter, wherein at least one of the RF sensing signals comprises a group of n independent and subsequent messages each modulated with a different frequency wherein the frequencies of the subsequent messages change in steps,
receiving the group of n subsequently transmitted messages by at least one RF receiver, and
performing a sensing operation based on the received group of n messages each transmitted with their respective frequency, wherein the sensing operation is based on Channel State Information (CSI)-based sensing or Received Signal Strength Indication (RSSI)-based sensing,
wherein the frequencies associated to the group of n messages are within a frequency range having an upper frequency and a lower frequency,
wherein the at least one RF transmitter and the at least one RF receiver which is receiving the RF sensing signal transmitted by the at least one RF transmitter are arranged spaced apart from each other and arranged to different location in sensing area, and wherein n messages are adapted based on the sensing operation.

11. Radio frequency sensing signal, comprising
a group of n independent and subsequent messages each modulated with different frequencies, wherein the frequencies of the subsequent messages change in steps,
wherein the frequencies associated to the group of n messages are within a frequency range having an upper frequency and a lower frequency, and wherein n messages are adapted based on a sensing operation.

12. Radio frequency sensing signal according to claim 11, further comprising
a preamble message comprising information regarding the number n, and frequency information regarding the frequencies of the n messages.

13. Computer program product for controlling a radio frequency sensing system, wherein the computer program product comprises program code means causing the radio frequency sensing system according to claim 1.
